(19) United States
(12) Patent Application Publication
(10) Pub. No.: US 2006/0129334 A1
(43) Pub. Date: Jun. 15, 2006

(54) Trench forming and preparing apparatus

(75) Inventor: Wayne Gregory Mitchell, Seymour (AU)

Correspondence Address: VOLPE AND KOENIG, P.C., UNITED PLAZA, SUITE 1600, 30 SOUTH 17TH STREET, PHILADELPHIA, PA, 19103, US

(73) Assignee: Mitchell Australasia Pty Ltd., West Melbourne (AU)

(21) Appl. No.: 10/536,609

(22) PCT Filed: Oct. 16, 2003
(86) PCT No.: PCT/AU03/01372

§ 371 Date: Oct. 31, 2005

(30) Foreign Application Priority Data
Nov. 28, 2002 (AU) 2002952972

(51) Int. Cl. G01B 3/00

(52) U.S. Cl. 702/33

(57) ABSTRACT

The specification discloses apparatus (10) for excavating a trench (18) and preparing a base region of the trench (18) for laying of a pipeline, cabling or the like therein, the apparatus (10) including a trench forming machine (11) driven in a forward direction (14) while excavating the trench (18), the appraatus (10) also including a device (13) for laying bedding material in the base region of the trench, the device (13) being integrally part of the trench forming machine (11) or being towed thereby, the apparatus (10) further including conveyor means (20, 22, 23) for conveying excavated trench material created by the trench forming machine (11) to the device (13) for laying bedding material into the trench (18), the device (13) including a vibrating screen separator (25) for separating fine particulate material from coarser excavated trench material whereby the fine particulate material is delivered to the base region of the trench (18).

The present invention relates to improved apparatus for creating and depositing bedding material in trenches, typically trenches for pipelines or the like.

It is conventional for a bedding material such as sand to be introduced into a trench to provide a smooth even bed on which a pipeline might be laid. Such bedding material might also conventionally be applied onto, around and immediately above such a pipeline whereby the pipeline is fully surrounded by the bedding material. In this way, no disconformities in the earth filling below, on either side or above the pipeline is achieved providing a sound support for the pipeline in the trench. The provision of a separate bedding and pipeline surround material such as sand or the like adds significantly to the costs associated with installing such a pipeline and these costs can be quite considerable when the pipeline extends over a relatively long distance.

Australian Patent Specification No. 592815 discloses apparatus capable of utilising at least part of the excavated trench material as a bedding and pipeline surround material for a pipeline. The apparatus disclosed in this patent specification is moved along and adjacent to the previously formed trench over the excavated trench material from the trench picking up at least a part of this material as the apparatus moves. This excavated trench material is conveyed rearwardly to a vibrating screen table which allows a proportion of fine particle material to pass through the screen onto a laterally directed conveyor located beneath the vibrating screen table. The laterally directed conveyor then conveys this fine particulate material back into the trench to act as a bedding and/or pipeline surround material for a pipeline or the like. This apparatus works well and has the significant advantage of avoiding the costs of having to separately bring in another bedding or pipeline surround material such as sand. The apparatus, however, requires control of the amount of excavated trench material picked up to control the amount of fine particulate material returned to the trench which inevitably is an inexact control of the fine material returned. This requires a certain degree of levelling operation of the bedding material to be carried out in the trench before a pipeline can be laid thereon.

Australian Patent Specification No. 18827/02 discloses apparatus that is moved along and within a previously formed trench with trench excavated material being placed onto a vibrating screen arrangement with such fine material being deposited directly into the base of the excavated trench with coarser material being returned to the ground adjacent the trench. As the apparatus moves along the trench a degree of levelling of the finer bedding material deposited in the base of the trench is achieved. Thus part of the problems associated with the apparatus disclosed associated with the apparatus disclosed in Australian Patent Specification No. 592815 are resolved, however, there remains the problems of having a trench forming machine undertake a first pass, the bedding material forming apparatus undertake a second pass along the trench and having separate machinery such as a front end loader or the like pick up and deposit excavated material onto the bedding material forming or supply apparatus. These separate handling and operational steps increase the number of operational personnel required, the operational steps involved and the machinery required thereby increasing the time and cost of installing pipelines.

The objective of the present invention is to provide apparatus capable of forming a pipeline trench and laying a pipeline bedding material from the excavated trench material into the trench via substantially a one pass operation without the need to bring to the site separate bedding or pipeline surround material such as sand or the like.

Accordingly, the present invention provides apparatus for forming a trench and preparing a base region of the trench for laying an elongate member such as a pipeline, cable or the like therein, said apparatus including a trench forming machine having excavating means adapted to excavate the trench as the trench forming machine is moved in a forward direction, a bedding material forming means positionable, in use, at least partly above the trench formed by the excavating means of said trench forming machine and being adapted to move simultaneously along said trench with said trench forming machine as the trench forming machine moves in said forward direction, said apparatus further including conveyor means for conveying at least a portion of excavated trench material created by said excavating means immediately after excavation to said bedding material forming means, said bedding material forming means including separation means for separating fine particulate material from the excavated trench material delivered thereto by said conveyor means whereby said fine particulate material is adapted to be delivered to the base region of said trench.

The pipeline bedding material forming means might conveniently be constructed as an integral part of the trench forming machine or alternatively, may be separate from the trench forming machine but pulled along the trench by connection means between the trench forming machine and the pipeline bedding material forming means. In this preferred embodiment, the connection means may be one or more cable(s) or chain(s) extending from a low point within the trench on the bedding material forming means to a more elevated position on the trench forming machine.

Preferred aspects and features of this invention may be as defined in claims 6 to 17 annexed hereto, which claims are hereby made part of the disclosure of this specification.

In accordance with a further aspect, the present invention provides a method of forming a trench and preparing a base region of the trench for laying an elongate member such as a pipeline or cable therein, said method including the steps of providing a trench forming machine and excavating ground material from a zone intended to form the trench while moving said trench forming machine in a forward direction, conveying at least a portion of said ground material excavated from said zone intended to form the trench immediately after excavation directly to separation apparatus for separating fine particulate material from the excavated ground material and depositing the fine particulate material into the base region of said trench as said separation apparatus is moved along said trench with said trench forming machine.

Preferred features of the foregoing method may be as defined in claims 20 to 23 annexed hereto, which claims are hereby made part of the disclosure of this invention.

By arrangements and methods as disclosed in the foregoing, it is possible to create a trench and simultaneously deposit a pipeline bedding material in the base of the trench during one pass of the machinery, thereby making significant time and cost savings.

In accordance with a still further aspect, the present invention provides a method of laying an elongate member (such as a pipeline, cable or the like) in an underground position, said method including the steps of providing a trench forming machine and excavating ground material from a zone intended to form a trench while moving said trench forming machine in a forward direction, conveying at least a portion of said excavated ground material from said zone intended to form the trench immediately after excavation directly to first separation apparatus for separating fine particulate material from the excavated ground material and depositing the fine particulate material into a base region of the trench as said first separation apparatus is moved along said trench, laying said elongate member on said fine particulate material in the base region of said trench, and thereafter passing second separation apparatus along said trench, said second separation apparatus also receiving at least a portion of said excavated ground material and delivering fine particulate material from said excavated ground material into said trench depositing same around and overs said elongate member. In a particularly preferred application of this method, the elongate member maybe a pipeline or conduit of continuous length or of joined separate sections.

Preferred features and aspects of the aforesaid method may be as defined in claims 25 to 30 inclusive as annexed hereto, the subject matter of these claims being made part of the disclosure of this specification by this reference thereto.

The method as outlined in the previous two paragraphs enables a pipeline, conduit or other elongate member to be positioned underground in an effective and relatively inexpensive manner when compared with the methods and costs of alternative existing processes to achieve a similar result.

Further preferred features and aspects of this invention will become apparent from the following description of a preferred embodiment given in relation to the accompanying drawings, in which:

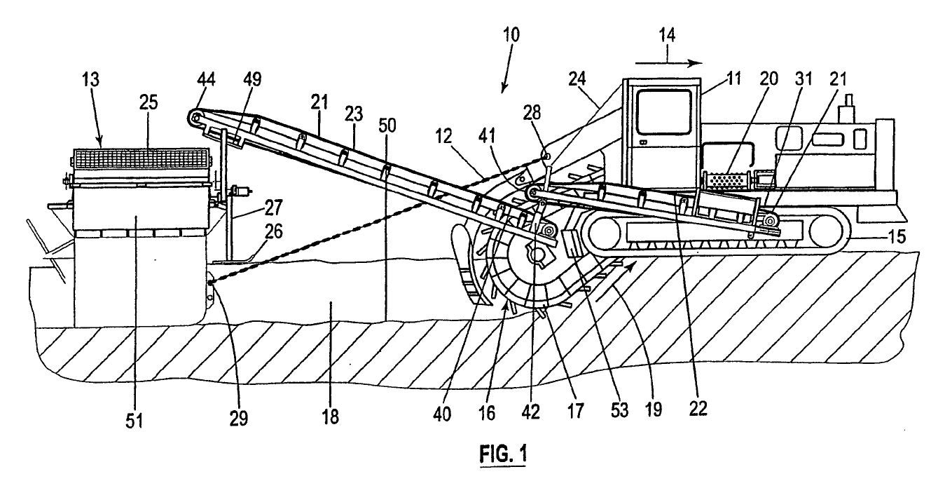

FIG. 1 is a schematic side elevation view of apparatus according to a preferred embodiment of this invention; and

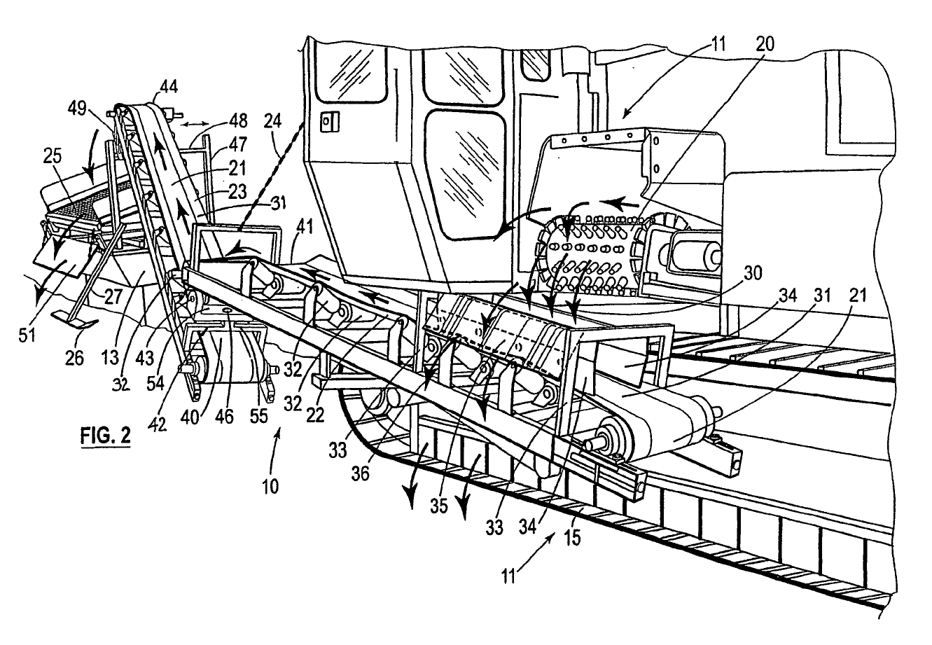

FIG. 2 is a partial perspective view of the apparatus of FIG. 1.

Referring to the drawings, the apparatus 10 includes a trench forming machine 11 connected via chain means 12 to pipeline bedding material forming apparatus 13. This apparatus may be generally the same as that shown in Australian Patent Specification No. 18827/02, the disclosure of this specification being hereby included in the current specification to the extent to which it may be necessary to understand any aspect of the present invention. The trench forming machine 11 moves forwardly in direction 14 supported on spaced crawler tracks 15 intended to be located on either side of the intended trench formation line for a desired pipeline. An excavation means 16 in the form of a toothed excavating conveyor is generally located between the spaced crawler tracks 15 and extends rearwardly of the trench forming machine 11. A digging region 17 of the excavating conveyor 16 may be raised or lowered by pivoting the conveyor 16 about a forward end to thereby vary the depth of the trench 18 being formed. When desired, the excavating conveyor 16 may be raised fully to a position clear of the ground for storage or for transport of the machine when a trench is not being formed. The structure of the excavation means 16 may vary depending on the nature of the ground in which the trench is formed. Any known form of excavation suitable for the purpose of forming a trench in the desired ground zone might be utilised.

Excavated material from the trench 18 is conveyed upwardly and rearwardly in the direction of arrow 19 by the excavating conveyor 16 to be deposited on a transversely extending first conveyor 20. This excavated material is carried by the first conveyor 20 to the side of the trench forming machine to be deposited either on a second conveyor 21 or on the ground as is explained in greater detail hereinafter. The second conveyor 21, in the embodiment illustrated in the drawings is formed as two separate conveyor sections 22, 23 which are conveniently supported at a mid point via a cable or a chain 24 from the trench forming machine super structure. The excavated material conveyed rearwardly on the second conveyor 21 is deposited at a rearward end onto an upper inclined vibrating screen table 25. The pipeline bedding material forming apparatus 13 is conveniently supported by skid elements 26 located on the ground on either side of the trench 18, the skid elements 26 being carried by outwardly inclined support bars 27 which conveniently can be of a telescopic construction to allow the height of the skid elements 26 to be adjusted when desired. The pulling chain 12 is conveniently connected at 28 to an elevated position on the super structure of the trench forming machine 11 and to a lower position 29 within the trench 18 on the apparatus 13.

As shown in FIG. 2, the first transverse conveyor 20 carries trench excavated material to the side of the trench forming machine 11. If the conveyor 20 is travelling at a relatively slow speed, ie at a speed below a predetermined limit, the excavated material drops as shown by arrows 30 onto the second conveyor 21. Conveniently, conveyor 21 is formed by a flexible endless belt 31 supported by rollers 32 to form a trough in which the excavated material is carried. At the receiving end 31 of the second conveyor 21, a frame structure 33 is provided supporting upstanding side plates 34 to minimize spillage of excavated material from the conveyor 21. In addition, an inclined baffle plate 35 is provided outwardly of the upstanding side plates 34 so as to direct any excavated trench material falling thereon to fall outwardly of the equipment as shown by arrows 36 and onto the ground adjacent the trench. Specifically, if the operator observes that too much trench excavated material is travelling up the second conveyor 21 to the pipeline bedding material forming apparatus 13, then the speed of the conveyor 20 is increased beyond the predetermined limit to ensure that most or all of the excavated material is thrown onto or beyond the inclined baffle plate 35. The apparatus includes control means to preferably infinitely vary the speed of the first transverse conveyor 20.

The second conveyor 21 is conveniently made in two sections 22 and 23. The second section 23, like the first section 22 is formed by an endless flexible belt 31 supported by rollers 32 to form a trough at least along its upper belt run to hold and carry excavated trench material. If desired, at the point where material drops from the first section 22 onto the second section 23, upstanding side walls might also be provided, like the side plates 34, to minimize spillage of excavated trench material. In addition the receiving end 40 of the second conveyor section 23 is supported underneath the discharge end 41 of the first conveyor section 22 via a connecting frame structure 42. The connecting frame structure 42 is pivoted about a generally horizontal axis 43 such that the discharge end 44 of the second conveyor section 23 may rise or fall relative to the receiving end 40. The connecting frame structure 42 is conveniently also formed in two parts 54, 55 pivoted together for relative pivoting movement about a vertical axis 46 whereby the discharge end 44 of the second conveyor section 23 may, in use, move in a lateral direction relative to the discharge end 41 of the first conveyor section 22.

Conveniently, the pipeline bedding material forming apparatus 13 includes an upstanding support frame structure 47 with a cross bar 48. The discharge end 44 of the second conveyor section 23 includes a pair of elongated skid bars 49 extending in the same direction as the conveyor section 23 and located beneath the discharge end 44 of the conveyor section 23 such that the skid bars 49 rest on the cross bar 48 of the frame structure 47. This configuration allows, in use of the equipment, for movement of the discharge end 44 of the second conveyor section 23 both in a fore and aft direction and in a lateral direction over at least small distances relative to the apparatus 13.

As also shown in FIG. 2, the excavated material dropping onto the vibrating screen table 25 from the conveyor section 23, will be vibrated to allow fine particulate material to pass downwardly towards the base 50 of the trench 18 (as described in Australian Patent Application No. 18821/02), with coarser material eventually dropping off the table 25 to the side of the trench. Conveniently a further inclined baffle plate 51 may be provided in this locality to direct the coarser material away from the trench and rearwardly of the stabilizing skid support members 26, 27. Currently, the rear end of the vibrating screen table device 25 includes a levelling and smoothing device to leave the fine material dropped into the trench substantially flat and level. This levelling and smoothing device may include a height adjustable plate with a V or similar formation in its lower edge to create a longitudinally extending groove in the deposited fine material into which a pipe may be laid.

It has also been recognized that the excavating conveyor 16 tends to throw at least a small amount of excavated material onto the edges of the trench being formed in the immediate vicinity of the excavating conveyor as the trench forming machine continues to operate. In some applications this is undesirable and to avoid this material remaining on the trench edges, scraper blades 53 are provided rearwardly of the crawler tracks 15 and positioned so as to direct any loose material back into the trench being formed for reprocessing by the excavating conveyor. Preferably, the scraper blades 53 may be supported from a pivoted frame member with an actuator being provided to adjust the height of the scraper blades 53 as may be needed from time to time or move same to an elevated transport position.

It will of course be recognised that the foregoing description given in relation to the annexed drawings is a description of one preferred embodiment and many variations within the ability and knowledge of a skilled addressee might be utilised within the general scope of the invention defined in the annexed claims.

The apparatus disclosed herein and particularly illustrated in the annexed drawings may be used in a process of forming an underground pipeline conduit or similar elongate member, such as cabling and the like. Thus the apparatus described above might be used to simultaneously form a trench and to place and level bedding material in its base region. Thereafter the elongate member (preferably a pipeline) may be laid on the bedding material by any convenient means including manual, partially manual or by mechanised means. After the elongate member (eg pipeline) has been placed in position, a second bedding material forming apparatus such as 13 in the drawings, or such as disclosed in Australian patent specification no. 18827/02, may be moved along the trench with previously excavated ground material being picked up and placed on its upper vibrating screen separator. The picking up and depositing of excavated ground material may be via a front end loader or any other suitable machinery. Once the elongate member (eg pipeline) has been effectively surrounded with a relatively fine particulate material, any remaining open region of the trench may effectively be back filled by any suitable method and machinery utilising any remaining previously excavated ground material.

What is claimed is:

1. Apparatus for forming a trench and preparing a base region of the trench for laying an elongate member such as a pipeline, cable or the like therein, said apparatus including a trench forming machine having excavating means adapted to excavate the trench as the trench forming machine is moved in a forward direction, bedding material forming means positionable, in use, at least partly above the trench formed by the excavating means of said trench forming machine and being adapted to move simultaneously along said trench with said trench forming machine as the trench forming machine moves in said forward direction, said apparatus further including conveyor means for conveying at least a portion of excavated trench material created by said excavating means immediately after excavation to said bedding material forming means, said bedding material forming means including separation means for separating fine particulate material from the excavated trench material delivered thereto by said conveyor means whereby said fine particulate material is adapted to be delivered to the base region of said trench.

2. Apparatus according to claim 1 wherein said bedding material forming means forms an integral part of said trench forming machine.

3. Apparatus according to claim 1 wherein said bedding material forming means is separate from said trench forming machine but in use is pulled along said trench by connection means to said trench forming machine.

4. Apparatus according to claim 3 wherein said connection means includes at least one cable or chain extending between said trench forming machine and said bedding material forming means.

5. Apparatus according to claim 4 wherein said at least one cable or chain is angled downwardly from said trench forming machine to said bedding material forming means with a connection of said at least one cable or chain to said bedding material forming means being below an upper edge of said trench.

6. Apparatus according to claim 1 wherein said conveyor means includes a first conveyor extending transversely relative to said trench said first conveyor being positioned to receive the excavated trench material from said excavating means and to deliver same at a downstream end of said first conveyor to a second conveyor extending rearwardly to said bedding material forming means.

7. Apparatus according to claim 6 wherein said first conveyor is made up of at least one individual conveyor unit.

8. Apparatus according to claim 6 wherein said second conveyor is made up of at least one individual conveyor unit.

9. Apparatus according to claim 6 wherein baffle means is provided adjacent the downstream end of said first conveyor whereby excavated material on said first conveyor is deposited on said baffle means if the first conveyor is moved at a speed above a first predetermined limit, and onto said second conveyor if the speed of said first conveyor is below the first predetermined limit, said baffle means being configured to deliver excavated material deposited thereon to a ground position adjacent said trench.

10. Apparatus according to claim 9 further including control means to vary the speed of said first conveyor to thereby selectably vary the amount of excavated trench material delivered by said second conveyor to said pipeline bedding material forming means.

11. Apparatus according to claim 1 wherein said trench forming machine includes scraper means arranged to push excavated material thrown out of the trench by said excavating means back into the trench to be reprocessed by said excavating means.

12. Apparatus according to claim 11 wherein said trench forming machine is supported on crawler track means on either side of the trench being formed by said excavating means, said scraper means being formed by ground engagable scraper blades positioned rearwardly of each crawler track means and adjacent to said excavating means.

13. Apparatus according to claim 1 wherein said pipeline bedding material forming means includes a structure positionable in the trench and configured to enable movement along the trench, said structure having a lower region adapted to receive said fine particulate material from said separation means and a lower face leading from said lower region through which said fine particulate material is discharged into a bottom region of said trench.

14. Apparatus according to claim 13 further including adjustable levelling means located rearwardly of the discharge of fine particulate material from said lower region of the structure to adjust the depth of said fine particulate material in said trench.

15. Apparatus according to claim 13 wherein the separating means includes a vibrating screen table that is wider than the trench and is inclined to one side whereby the excavated material deposited thereon that does not pass through the screen table drops from the screen table on said one side to a ground position.

16. Apparatus according to claim 15 wherein support skids are positioned to engage the ground on either side of the trench and on either side of the bedding material forming means in front of any excavated material falling from the vibrating screen table.

17. Apparatus according to claim 16 wherein the height of said support skids relative to the structure within said trench is adjustable.

18. A method of forming a trench and preparing a base region of the trench for laying an elongate member such as a pipeline or cable therein, said method including the steps of providing a trench forming machine and excavating ground material from a zone intended to form the trench while moving said trench forming machine in a forward direction, conveying at least a portion of said ground material excavated from said zone intended to form the trench immediately after excavation directly to separation apparatus for separating fine particulate material from the excavated ground material and depositing the fine particulate material into the base region of said trench as said separation apparatus is moved along said trench with said trench forming machine.

19. A method according to claim 18 wherein said separation apparatus includes a portion located in said trench, said portion including means for distributing and levelling the fine particulate material in the base region of the trench.

20. A method according to claim 19 wherein said means for distributing and levelling the fine particulate material in the base region of the trench includes means for creating a groove in said fine particulate material into which the elongate member is laid.

21. A method according to claim 18 wherein a portion of the excavated ground material is selectably deposited onto the ground adjacent the trench instead of being conveyed to the separation apparatus.

22. A method according to claim 18 wherein coarser particulate material of said excavated ground material that is not deposited into the base region of the trench is discharged from said separation apparatus onto the ground adjacent said trench.

23. A method of laying an elongate member in an underground position, said method including the steps of providing a trench forming machine and excavating ground material from a zone intended to form a trench while moving said trench forming machine in a forward direction, conveying at least a portion of said excavated ground material from said zone intended to form the trench immediately after excavation directly to first separation apparatus for separating fine particulate material from the excavated ground material and depositing the fine particulate material into a base region of the trench as said first separation apparatus is moved along said trench, laying said elongate member on said fine particulate material in the base region of said trench, and thereafter passing second separation apparatus along said trench, said second separation apparatus also receiving at least a portion of said excavated ground material and delivering fine particulate material from said excavated ground material into said trench depositing same around and over said elongate member.

24. A method according to claim 23, wherein said elongate member is a pipeline or conduit of continuous length or of joined separate sections.

25. A method according to claim 23, wherein said first separation apparatus is part of or operationally connected to said trench forming machine.

26. A method according to claim 25, wherein said first separation apparatus includes a portion located in said trench, said portion including means for distributing and levelling the fine particulate material in the base region of the trench.

27. A method according to claim 26, wherein said means for distributing and levelling the fine particulate material in the base region of the trench includes means for creating a groove in said fine particulate material into which the elongate member is laid.

28. A method according to claim 23, wherein a portion of the excavated ground material is selectably deposited onto the ground adjacent the trench instead of being conveyed to the first separation apparatus.

29. A method according to claim 23, wherein coarser particulate material of said excavated ground material that is not deposited into the base region of the trench is discharged from said first separation apparatus onto the ground adjacent said trench.

30. A method according to claim 28, wherein the excavated ground material deposited on the ground is at least partially picked up and delivered to said second separation apparatus.
